(19) United States
(12) Patent Application Publication
(10) Pub. No.: US 2026/0064969 A1
(43) Pub. Date: Mar. 5, 2026

(54) SYSTEM AND METHOD FOR AUDIENCE-BASED CUSTOMIZATION OF GENERATIVE ARTIFICIAL INTELLIGENCE (AI)

(71) Applicant: Wells Fargo Bank, N.A., San Francisco, CA (US)

(72) Inventors: Rameshchandra Bhaskar Ketharaju, Hyderabad (IN); Anjeet Kumar, Bangalore (IN); Ramesh Babu Sarvesetty, Bangalore (IN); Shuvam Sengupta, Kolkata (IN); Gaurav Sharma, Bengaluru (IN)

(21) Appl. No.: 18/817,048

(22) Filed: Aug. 27, 2024

(51) Int. Cl. G06F 40/284

(52) U.S. Cl. CPC G06F 40/284

(57) ABSTRACT

Systems and methods are provided, that include receiving a request from a requestor for an artificial intelligence (AI)-generated output, and determining an intended audience for the AI-generated output based on the request. The systems and methods also creating an audience-based response to the request by using a trained large language model (LLM) or a combination of the trained LLM and an LLM style-based embedding. Using the trained LLM includes generating a base response to the request using the trained LLM, and applying one or more audience-specific transformation systems to the base response to create the audience-based response, wherein the one or more audience-specific transformation systems are configured to modify the base response for the intended audience. The systems and methods additionally include providing the audience-based response as the AI-generated output to the requestor.

### TECHNICAL FIELD

The present disclosure generally relates to generative artificial intelligence, and more specifically to audience-based customization of generative artificial intelligence.

### BACKGROUND

Generative artificial intelligence creates content, such as images, text, music, and videos, mimicking human creativity. These systems learn to provide their output via training on vast amounts of existing data. By learning from vast amounts of existing data, the generative AI can produce novel outputs that often exhibit creativity and diversity, comparable to human-generated content in certain aspects.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document. Various ones of the appended drawings merely illustrate example embodiments of the present inventive subject matter and cannot be considered as limiting its scope.

FIG. 1 is a block diagram of an audience-based generative AI system, according to some examples.

FIG. 2 is a flowchart illustrating a process for automatically generating audience-based generative AI outputs, according to some examples.

FIG. 3 is a block diagram illustrates a machine learning engine suitable for training one or more LLMS to create the trained LLMs and/or LLM-based styles, according to some examples.

FIG. 4 is a block diagram of a transformer model used as one or more of the trained LLMs and/or styles 136, according to some examples.

FIG. 5 is a block diagram depicting a machine suitable for executing instructions via one or more processors, according to some examples.

### DETAILED DESCRIPTION

Reference will now be made in detail to specific example embodiments for carrying out the inventive subject matter. Examples of these specific embodiments are illustrated in the accompanying drawings, and specific details are set forth in the following description in order to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

The techniques described herein solve various technical problems such as automating the creation of generative artificial intelligence (AI) output that has been trained on very large volumes of data, including financial data, to more efficiently derive an audience-based output that is specifically focused on an audience. Rather than provide one-size-fits all explanations, an audience-based generative AI system described herein automatically adapts to different audiences, such as various roles within an organization, and provides different levels of detail or types of information based on the adapted audience. That is, users from different domains benefit from generative AI explanations that reference domain-specific knowledge or jargon and that “fit” the user's level of experience and knowledge. In certain examples, the audience-based generative AI system dynamically selects an appropriate explainability framework based on the adapted audience to deliver more pertinent information that provides for a more domain-relevant output. The explainability framework includes, for example, certain vector embeddings further described below, that are used to represent the specific styles and language preferences of different audiences. These vector embeddings capture the nuances of how various user groups, such as financial professionals or technical experts, communicate and understand information.

In some examples, the techniques described herein include the concept of “styles” to tailor the audience-based generative AI system explanations to the communication preferences and understanding levels of different user groups and/or roles. For example, a style applies a concept similar to artistic style transfer to the domain of AI-generated explanations. Just as an artist's style can be applied to a painting, the AI systems described herein can apply different explanation styles to a base explanation to suit the audience's preferences. The audience-based generative AI system creates audience styles that capture the unique communication styles of different user groups and/or roles. These styles reflect the language, terminology, and presentation that are most effective for each audience. As used herein, “role” refers to a function or position held by an individual or an entity within an organizational or operational context. Examples of roles include, but are not limited to, financial experts, software developers, information technology (IT) personnel, legal professionals, regulatory agents, customers, and/or laypersons, each usually having different styles and depths of explanation based on their unique duties and expertise.

The audience-based generative AI system also includes techniques to minimize or eliminate hallucinations (e.g., fabricated answers or “odd” answers). For example, the styles can be used to ensure that the style of explanation remains appropriate for the intended user group during use. By monitoring style-specific embeddings, the system can prevent the denormalization of explanations that could lead to hallucinations, as further described below. By addressing these technical problems, the invention enhances the usability and accessibility of generative AI systems, making them more effective tools for a variety of users across different domains.

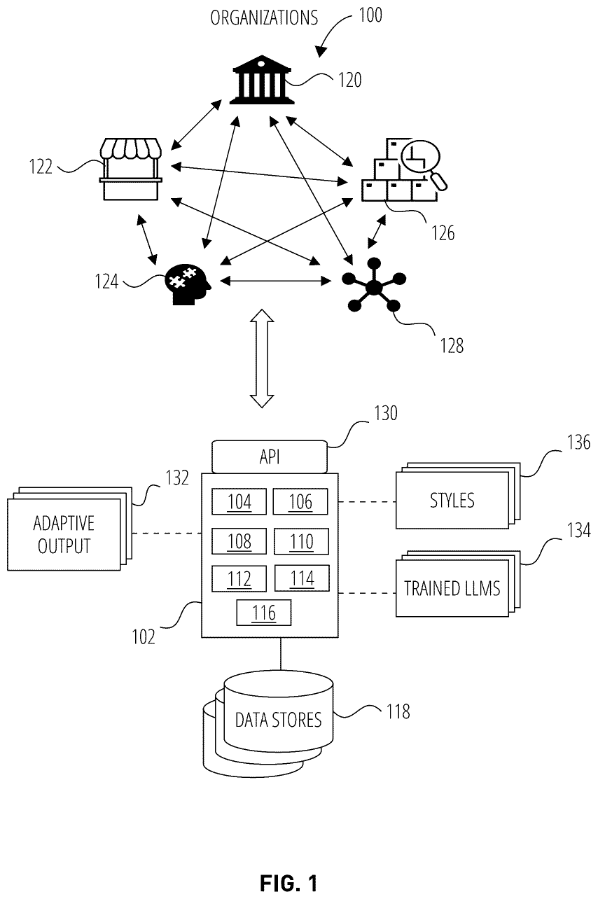

FIG. 1 illustrates an example organizations 100 and an audience-based generative AI system 102, according to some examples. In the depicted example, the audience-based generative AI system 102 includes a data collection system 104, an adaptive explanation generation system 106, an audience embeddings system 108, a style applicator system 110, a retrieval augmented generation system 112, an authentication system 114, and a user interface (UI) system 116. Data stores 118 are also shown, suitable for storing a variety of data. The audience-based generative AI system 102 can be used by various entities 120, 122, 124, 128, 126, for example, to provide with more focused generative AI services to the various organizations 100. For example, a financial entity 120 (e.g., retail and commercial bank, investment bank, brokerage firm, mortgage company, and so on) can provide virtual assistants, online virtual support, and the like, based on the audience-based generative AI system 102. The audience-based generative AI system 102 can provide answers and/or guidance on financial products and/or services such as loans, investment products, checking and savings accounts, insurance products, and the like, offered by the financial entity 120. Employees and customers of the financial entity 120 can thus use the audience-based generative AI system 102 to increase productivity and improve customer experience.

Any type and number of organizations 100 can use the audience-based generative AI system 102. Other organizations 100 include merchant entities 122. The merchant entities 122 sell a variety of goods, including online goods, manage physical store location(s), and so on, and can include a variety of small business. The merchant entities 122 also include entities that produce goods for sale, such as farming entities, restaurants, manufacturing entities (e.g., small manufacturers), and the like. Service provider entities 124 provide a variety of services, such as gig economy services (e.g., drivers, short-term rental providers, long-term rental providers, and the like), consulting services, contractor services, plumbing services, electrician services, software services, legal services, medical and health service providers, and so on. Participant entities can also include suppliers and/or supply chain entities 126, which supply a variety of products including raw materials, manufactured parts, finished goods, and the like. In some cases, an entity of the organization 100 can provide merchants goods, but additionally provide services, supplies, or a combination thereof.

Also shown are social networks 128. In some examples, entities in a social network 128 are members of an organized group, such as a farming community, a sales group, a union, a business bureau, and so on. The social network 128 also includes more loosely organized groups of entities, such as friends, influencers, followers, and so on. Entities 120, 122, 124, 126, 128 can interact with the audience-based generative AI system 102, for example, via an application programming interface (API) 130. In certain embodiments, the API 130 is accessed via API keys (e.g., public/private keys) used to provide authentication and security. The API 130 exposes a set of objects (e.g., classes, functions, callable code) to interface with and use the audience-based generative AI system 102, including the data collection system 104, the audience embeddings system 108, the style applicator system 110, the retrieval augmented generation system 112, and the UI system 116. It is to be noted that the audience-based generative AI system 102 and the API 130 can be provided by an organization 100, such as the financial entity 120, by a third-party, such as a software-as-a-service (SaaS) cloud provider, or a combination thereof.

The data collection system 104 provides for data gathering and tagging of certain data from the various organizations 100. In operation, the data collection system 104 is programmed to automatically collect data from specified organizations 100 at regular intervals and/or in real-time, and store the collected data in the data stores 118. The data collection system 104 identifies and extracts specific types of data, such as an organization's public documents, training manuals, and/or other data provided by the organization, for example, that are then provided for use by the audience-based generative AI system 102. The data collection system 104 additionally builds training profiles and/or training data sets by aggregating the collected data and tagging the collected data as more relevant to specific groups or roles. For example, new accounting manuals are tagged as more relevant to accounting groups or financial roles, updated regulatory documents are tagged as more relevant to compliance groups, new software security bulletins as more relevant to software developers, and so on.

The adaptive explanation generation system 106 generates adaptive outputs 132 that are tailored to the needs and understanding levels of different user groups. More specifically, the adaptive explanation generation system 106 dynamically customizes the content of AI-generated explanations based on the specific audience or user group. This involves adjusting the level of detail, the complexity of information, and the type of language used so that the explanation is more accessible and understandable to the intended audience. The adaptive explanation generation system 106 implements adaptive explanation frameworks that modify the explanation generation process based on the audience's characteristics. This includes selecting more appropriate trained LLMs 134 and applying the relevant explainability framework during the generation of the output. These trained LLMs 134 are trained to include detailed information relevant to various professional fields, such as financial, technical, medical, legal domains, and the like.

In some examples, the adaptive explanation generation system 106 integrates with the style applicator system 110 to alter the presentation style of a base explanation to better suit the preferences of different user groups and/or roles. This might involve changing the verbosity, formality, or even the structure of the information presented, akin to how an artist might change their painting style. The style applicator system 110 facilitates the creation, management, and execution of AI generative styles 136. AI generative styles 136 include the choice of words (e.g., diction), the complexity of vocabulary, and the use of specific terminologies or jargon that may be familiar to a particular professional group, role, and/or industry. That is, the AI generative styles 136 are used to transform outputs provided by the trained LLMs 134 to then result in the adaptive outputs 132. In certain example, a base style provided by the trained LLMs 134 is then modified by applying the AI generative styles 136 via the style applicator system 110. The adaptive explanation generation system 106 then further processes the style-specific explanation to then create the adaptive output 132.

The retrieval augmented generation system 112 begins by retrieving relevant information from the data stores 118. This retrieval is typically based on the input query or context provided to the system. The retrieved information is then used to augment the capabilities of one or more of the trained LLMs 134. This means that the language model has access to specific, detailed, and relevant external information at the time of generating text, which helps in producing more accurate and contextually appropriate outputs. By integrating external knowledge, the retrieval augmented generation system 112 allows the audience-based generative AI system 102 to have a broader understanding of the context beyond the limited scope of its internal training data. This is particularly useful for generating explanations or content in fields where new information is constantly emerging, such as financial, legal, and/or technical fields.

The authentication system 114 authenticates users of the audience-based generative AI system 102, for example, via multi-factor authentication. A user of the audience-based generative AI system 102 enters a user/password combination, and the authentication system 114 will verify the combination and transmit a code to the user to further authenticate a login into the audience-based generative AI system 102. Communications of the audience-based generative AI system 102 are encrypted, for example using Transport Layer Security (TLS), to prevent eavesdropping and man-in-the-middle attacks. The authentication system 114 also provides for password policies suitable for using complex passwords and regular changes to reduce the risk of compromise.

The UI system 116 provides for a graphical user interface that includes windows, icons, menus, buttons, and all the other elements that are manipulated by the user with a pointing device like a mouse or touchpad. Command-Line Interfaces (CLIs) are also provided via the UI system 116. The CLIs allow users to interact with the audience-based generative AI system 102 by typing commands into a terminal or command prompt. The UI system 116 also provides for touch interfaces designed for touch screens. These touch interfaces allow users to interact with the audience-based generative AI system 102 through touch gestures such as tapping, swiping, and pinching. Voice User Interfaces (VUIs) are also included in the UI system 116. The VUIs enable interaction with the audience-based generative AI system 102 through voice or speech commands.

In operations, the audience-based generative AI systems 102 is used by the entities 120, 122, 124, 126, 128 to enhance their decision-making processes and to provide certain offerings, such as customer support offerings. For example, questions about financial products (e.g., loans, lines of credit, credit cards), transaction and payment services (e.g., wire transfers, mobile payment services, point-of-sale services, and so on), investment products (e.g., stock and bonds, cryptocurrencies), and so on, which can be automatically provided to the different organizations 100 and to groups and/or individuals associated with the organizations 100 based on the Indeed, even without a traditional financial history (e.g., credit history, banking history), an entity 120, 122, 124, 126, 128 can now financially participate in a variety of transactions based on the adaptive output 132, the styles 136, and/or the trained LLMs 134.

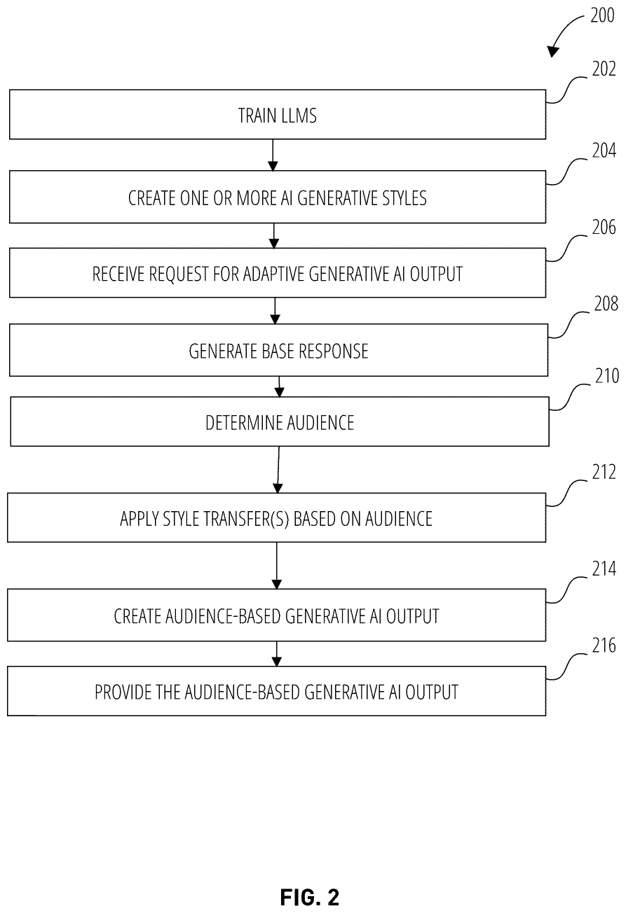

FIG. 2 is a flowchart of an embodiment of process 200 for generating the adaptive output 132, according to some examples. In the depicted example, the process 200 trains, at block 202, one or more large language models (LLMs), to create the trained LLMs 134. For example, the process 200 collects, via the data stores 118, a large and diverse dataset that includes a wide range of texts across different domains, styles, and formats. The training datasets includes large corpus of training data, such as a common crawl dataset, a cleaned common crawl (C4) training dataset, Wikipedia, and so on. Training datasets additionally include the use of synthetic data, such as data created specifically for training purposes. These training dataset additionally include domain-specific data such as specific financial texts, technical documents, legal texts, business reports, casual conversations, and the like. For each target audience or user group, domain-specific data help the models learn the appropriate jargon, style, and content for one or more audiences. For example, financial documents aid in training the LLMs for use by banking professionals, legal documents are used in training the LLMs for use by legal professionals, technical manuals are used to train the LLMs for use by engineers, and so on.

Training the LLMs includes removing noise from the data, such as formatting issues and removing errors, as well as normalizing the text to ensure consistency (e.g., lowercasing, punctuation normalization). Training the LLMs also include tokenization or the conversion of the text into tokens (words or subwords), which are the basic units for model training. Training the LLMs also include selecting one or more model types to use. For example, one or more base model architectures are selected, such as a Transformer-based model like Bidirectional Encoder Representations from Transformers (BERT), Large Language Model Meta AI (Llama), Generative Pre-trained Transformer (GPT), and so on. These models are favored for their ability to handle complex language tasks and their capacity for transfer learning.

In some examples, the training at block 202 additionally includes retrieval augmented training that incorporates certain mechanisms that use external knowledge bases (e.g., data stores 118 having more focused domain knowledge) during training, such as via the retrieval augmented generation system 112. This helps the LLMs learn to incorporate focused external information (e.g., financial information, legal information, engineering information, customer support information) into its outputs, enhancing accuracy and relevance. More specifically, retrieval augmented training includes training a retriever model to fetch relevant data or documents from certain data stores 118 that stored certain more focused domain information, such as financial documents, manuals, procedures, legal statutes, regulatory codes, treatises, and so on. Training additionally includes training one or more generative models to use the data retrieved via the retriever model and the input query to generate a coherent and contextually appropriate response.

The process 200 also creates, at block 204, one or more AI generative styles 136. Creating the one or more AI generative styles 136 includes identifying an audience, such as user groups and/or roles, who will interact with the AI system. This includes identifying the audience's professional backgrounds, the complexity of information they handle, and their specific uses of information consumption. Example audiences include financial professionals, business executives, bank customers, legal professionals, laypersons, employees of various types and levels in an organization, and so on. For each user group and/or role identified, the process 200 defines the attributes that make up a style. These attributes can include language complexity, terminology, tone, format, and level of detail. For example, for financial professionals, the style might be formal and precise, using financial jargon and structured formats.

In certain examples, the AI generative styles 136 or audience-based transformation systems are based on other trained LLMs 134. For example, a style-processing LLM is trained to take as input a base explanation generated by another LLM (e.g., another audience-based transformation system) and to adapt the base explanation based on the intended audience. Accordingly, a base explanation of a financial transaction, for example, is then adapted into a more formal version for regulators or a simplified version for the general public. Some example model architectures that are used for the AI generative styles 136 include sequence-to-sequence models (Seq2Seq), variational autoencoders (VAEs), and/or generative adversarial networks (GANs), and/or Transformer-based models.

Seq2Seq models are based on recurrent neural networks (RNNs) or Transformers, and are trained to map input sequences (text in the original style) to output sequences (text in the target style based on the audience's defined attributes). The Seq2Seq models thus learn to maintain content while altering the content to achieve the desired style. VAEs are used for style transfer by learning a latent representation of the input base text and then modifying aspects of this representation that correspond to style. GANs are adapted for style transfer by training a generator to produce text that is indistinguishable from a target style and a discriminator to distinguish between the generated text and authentic text in the target style. Other Transformer-based models are similarly fine-tuned for style transfer tasks, leveraging their ability to handle long-range dependencies and context.

Training data for the AI generative styles 136 includes a parallel corpus, a non-parallel corpus, or both. A parallel corpus contains pairs of sentences with the same content but with different styles. For example, a dataset might have formal and informal versions of the same sentence, as well as a base sentence and equivalent style sentences. A non-parallel corpus data (separate collections of text in each style) is also used, that can learn style features without direct content equivalences. With non-parallel corpus data, unsupervised techniques such as cycle consistency (where the model learns to translate from one style to another and back again) is employed.

In some examples, the styles 136 are not LLMs themselves but instead are LLM embeddings, such as vector-based embeddings, that can be dynamically used as desired. Embeddings are numerical representations of words, phrases, or sentences that capture their meanings, syntactic properties, and semantic relationships. The vector-based embeddings are designed to convert categorical data (like words) into continuous vector spaces where similar items are positioned close to each other. This enables neural networks to operate on numerical data. In the depicted training example at block 204, The embeddings are initialized as random vectors. Each word or token in the vocabulary is assigned an initial vector. During the training process of an LLM, such as the trained LLMs 134, these vectors are adjusted based on the context in which the words appear. In some examples, the adjustment is performed through backpropagation, where the model learns to predict a word based on its context, thereby refining the vectors to capture semantic similarities and syntactic roles.

The techniques herein include trained embeddings to provide for audience-based generation of AI output as well as for one or more of the styles 136. The training of the embeddings includes gathering large and diverse datasets that are representative of each audience and/or style to be modeled. For example, audience-based documents include the aforementioned financial documents, legal documents, engineering documents, IT documents, and so on. If you are targeting formal and informal styles, you would collect a corpus of formal documents (e.g., academic papers, legal documents) and a corpus of informal texts (e.g., casual conversations, social media posts). The training then cleans and preprocess the training data. This typically includes tokenization, normalization (like converting to lowercase, removing punctuation), and possibly removing stop words or other irrelevant information. Various types of models are used for the embedding training. For example, word-level models such as Word2Vec or GloVe are used to train word-level embeddings for desired styles. For example, data is labeled using one or more audience labels (e.g., financial audience, bank customer audience, regulatory audience, and so on), and one or more style attributes (e.g., language complexity, terminology, tone, format, and level of detail). These models capture the context, audience, and style of a word in a fixed-size vector. Sentence or document-level models are also used, which capture audience and styles, including style attributes, that are more dependent on larger contexts or the structure of text, sentence or document-level embeddings might be more appropriate. Models like Doc2Vec or sentence Transformers can be used. Contextual embeddings can also be trained, such as via models like BERT or GPT provide contextual embeddings based on the Transformer architecture discussed in more detail below. These models consider the context of each word in a sentence, enabling a richer representation of style.

When using models such as Word2Vec or GloVe, training the model on style-specific corpora involves sliding a window across the text and predicting words based on their context (or vice versa), adjusting the word vectors to reduce prediction error. When using models like Doc2Vec then training involves treating entire sentences or documents as single units in a similar predictive framework, or using sentence transformers that leverage pre-trained Transformer models fine-tuned on specific style datasets. When training models such as BERT, fine-tuning and pre-training on tasks that are representative of each style is performed, such as style-specific classification, paraphrasing, or text generation tasks.

During use of the audience-based generative AI system 102, the process 200 then receives, at block 206, a request for adaptive generative AI output. For example, the request includes a question or command, such as a financial question, a command to analyze a legal document, a command to summarize a book, and so on. The request can be received via the API 130, the UI system 116, or both. The process 200 then authenticates the request, for example, using the authentication system 114. Once the request is authenticated, the process 200 then generates, at block 208, a base response to the request. The base response is generated via one or more of the trained LLMs 134, such as LLMs that have been previously trained in block 202. In some examples, the retrieval augmented generation system 112 is also used to improve the base response with more focused domain knowledge.

The process 200 then, at block 210, determines an audience associated with the request for the adaptive generative AI output. In one example, the request itself includes a sub-request that the resulting output be adapted for one or more audiences. For example, a request can state “Describe the 2002 Sarbanes-Oxley Act as it pertains to a consumer checking account first in terms that a layperson bank client can understand and then in terms that an accredited investor can understand.” The process 200 additionally or alternatively determines the audience based on an online platform used to submit the request. For example, an online customer help platform is representative of a layperson audience, while an organization's online financial query platform used by financial advisors is representative of a financial expert audience. The process 200 additionally or alternatively determines the audience based on a computer account used to submit the request. For example, certain computer accounts include a role associated with the computer account, such as a customer support role, an IT support role, a programmer role, a financial analyst role, a legal representative role, and so on.

For each derived audience, the process 200 also derives audience attributes that include language complexity, terminology, tone, format, and level of detail. In some examples, once the audience group and/or role is determined, then an attributes table, such as a table stored in one or more of the data stores 118, is accessed that stores the audience's attributes. For example, if the audience is determined to be “certified financial planner (CFP)” then the language complexity is retrieved to be “high”, the terminology is retrieved to be “financial expert”, the tone is retrieved to be “formal”, the format is retrieved to be “technical” and the level of detail is retrieved to be “very detailed.” In some examples, the user can also enter one or more of the desired audience attributes via the UI system 116 and/or API 130.

The process 200 then applies, at block 212, one or more styles 136 to the base output to transfer the applied styles based on the audience. In certain examples, the process 200 uses audience attributes language complexity, terminology, tone, format, and/or level of detail to apply the desired style. For example, the audience and the audience attributes are given as input to one or more of the generative AI styles 136 which will then adapt the base response based on the style's audience and audience attributes. In examples where the generative AI styles 136 include LLMs, one or more style-specific LLMs are chosen to be applied to the output base response and the audience attributes are also then provided as input to the LLMs.

In examples where the styles 136 are not LLMs themselves but instead include LLM embeddings, then suitable style embeddings are used based on the desired audience. That is, one or more embedding-based styles 136 are selected based on the desired audience and audience attributes. The selected embeddings are then concatenated with the base text embeddings (e.g., from the base response generated at block 208). In this approach, each vector from the base text is extended by appending the style vector, effectively creating a new set of embeddings that carry both content and style information. This concatenated vector is then fed into the generative model of choice, such as one or more of the trained LLMs 134. In another example, the style embeddings are added to the base text embeddings element-wise. This element-wise addition is used when both sets of embeddings are of the same dimension and combines them by adding corresponding elements. These combinations of style embeddings and base text embeddings allow style features to directly modulate the base content features.

The output resulting from the application of the generative AI styles 136 is then used to create, at block 214, audience-based generative AI output. In examples where the styles 136 are based on a style-trained LLM that modifies the output of another more generally trained LLM, the process 200 provides the output of the generally trained LLM to the style-trained LLM to create the audience-based generative AI output. In examples where the styles 136 include embeddings, the process 200 uses the combined embeddings (e.g., style-based embeddings combined with standard text embeddings) to be used by the more generally trained LLM. The resulting output then becomes the audience-based generative AI output. Once the audience-based generative AI output is created, the process 200 provides, at block 216, the audience-based generative AI output, for example, to the requestor that initiated the original request at block 202. By providing for the audience-based generative AI output, the techniques described herein produce text that is not more only contextually and stylistically appropriate, but also more engaging and effective for the intended audience.

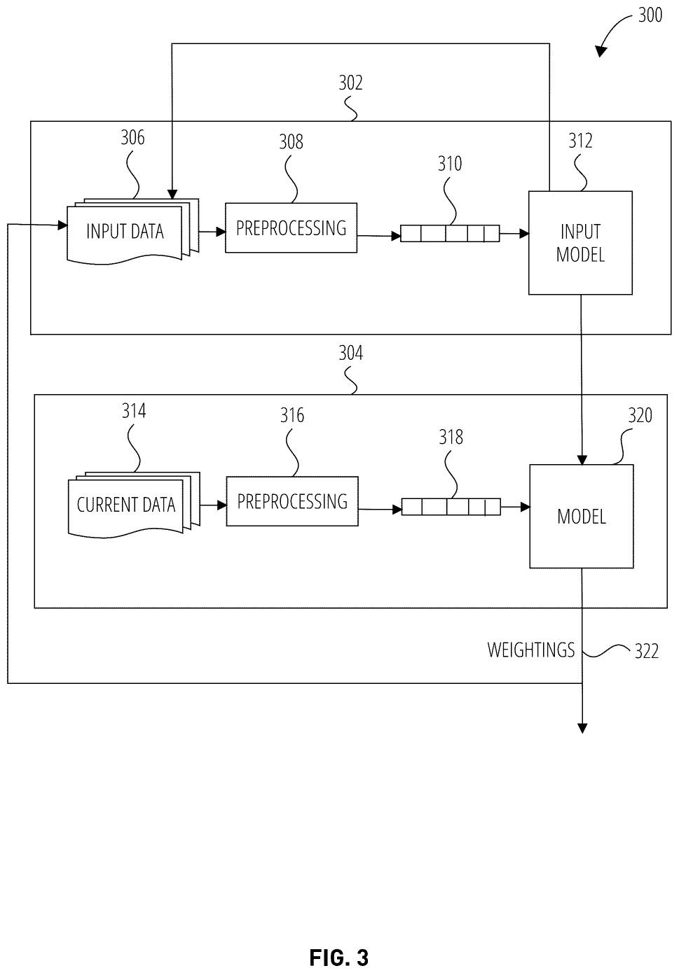

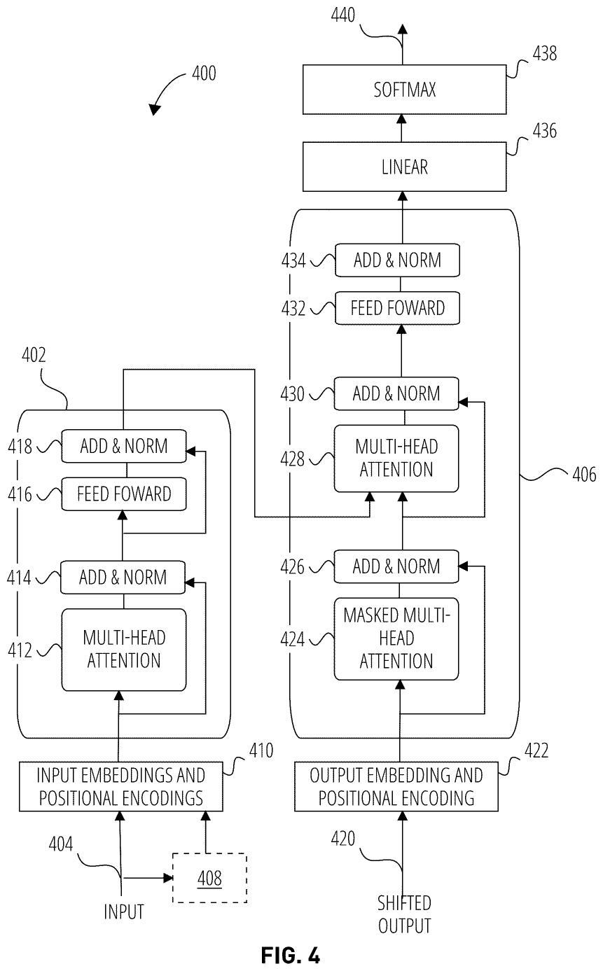

FIG. 3 illustrates a machine learning engine 300 suitable for training the one or more LLMS to create the trained LLMs 134 and/or the LLM-based styles 136, in accordance with some embodiments. The machine learning engine 300 may be deployed to execute at a mobile device (e.g., a cell phone), a computer, a server, a cloud-based system, and so on. In some examples, a system, such as the audience-based generative AI system 102, may calculate one or more weightings for criteria based upon one or more machine learning algorithms via the machine learning engine 300, used in training the transformer model 400 of FIG. 4. For example, the weightings for the LLMs that will be used for styles 136 include weightings for audience attributes such as language complexity, terminology, tone, format, and level of detail.

In the depicted example, the machine learning engine 300 uses a training engine 302 and a prediction engine 304. The training engine 302 uses input data 306, for example after undergoing preprocessing via the preprocessing component 308, to determine one or more features 310. The one or more features 310 may be used to generate an initial input model 312, which may be updated iteratively or with future labeled or unlabeled data (e.g., during reinforcement learning or fine tuning).

The input data 306 includes a large corpus of subject matter material, including general knowledge such as history, geography, science, literature, arts, and popular culture; technology such as computer science, software development, artificial intelligence, machine learning, and emerging technologies; and business and finance such as economics, marketing, management, entrepreneurship, accounting, and financial markets, among other subject matter material. In some examples, open source training data sets such as C4, common crawl, and/or Wikipedia are used as the input data 306, along with synthetic data.

In certain examples, the training data also includes data that is labeled as belonging to a certain style and/or style attribute. For example, data written in different language complexities is labeled as “low”, “medium”, “high”, “medium low”, “medium high”, and so on. Data written using different terminologies is labeled as “financial expert”, “bank customer”, “teller”, “bank executive”, “IT support”, and so on. Data written in different formats is labeled as “conversational”, “technical”, “educational”, and so on. Data written in different levels of detail is labeled as “low detail”, “medium detail”, “high detail”, and so on. By labelling the data using different styles and/or style attributes, various models can be trained to recognize and to provide style-based output and/or embeddings.

Fine tune training includes using detailed knowledge of an organization 100 that will be using the audience-based generative AI system 102. The detailed knowledge includes organizational structure, organizational functions, organization's responsibilities, organization's duties, organization's mission, department descriptions, department functions, department responsibilities, department duties, employee job description, employee responsibilities, employee duties, organizational charts, organizational procedures and processes, department procedures and processes, employee procedures and processes, and other forms of organizational knowledge.

In the prediction engine 304, current data 314 may be input to preprocessing component 316. In some examples, preprocessing component 316 and preprocessing component 308 are the same. The prediction engine 304 produces feature vector 318 from the preprocessed current data, which is input into the model 320 to generate one or more criteria weightings 322. The criteria weightings 322 may be used to output a prediction, as discussed further below.

The training engine 302 may operate in an offline manner to train the model 320 (e.g., on a server). The prediction engine 304 may be designed to operate in an online manner (e.g., in real-time, at a mobile device, on a wearable device, etc.). In some examples, the model 320 may be periodically updated via additional training (e.g., via updated input data 306 or based on labeled or unlabeled data output in the weightings 322) or based on identified future data, such as by using reinforcement learning to personalize a general model (e.g., the initial model 312) to a particular user and/or organization. Labels for the input data 306 may include organizational labeling of certain knowledge, including anonymous labeling, e.g., “employee A.”

The initial model 312 may be updated using further input data 306 until a satisfactory model 320 is generated. The model 320 generation may be stopped according to a specified criteria (e.g., after sufficient input data is used, such as 300,000, 1 million, 2 billion data points, etc.) or when data converges (e.g., similar inputs produce similar outputs).

The specific machine learning algorithm used for the training engine 302 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 302. In an example embodiment, a regression model is used and the model 320 is a vector of coefficients corresponding to a learned importance for each of the features in the vector of features 310, 318. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like. Once trained, the model 320 may now correspond to the trained transformer model 400.

It may be beneficial to describe an architecture used for one or more of the trained LLMs 134 and/or styles 136. Turning now to FIG. 4, the figure is a block diagram of a transformer model 400 used as one or more of the trained LLMs 134 and/or styles 136, in accordance with some examples. In the depicted example, an encoder 402 maps an input 404 (e.g., input tokens or words in a sentence) into a sequence of continuous representations to be fed into a decoder 406. That is, the encoder 402 converts the input 404 into a continuous representation that retains the semantic information of the input 404. This process involves embedding the tokens into a high-dimensional space, some examples, via vector-based embeddings. For example, input embeddings and positional encodings 410 are created and used to represent the input 404. Input embeddings and positional encodings transform discrete input 404 elements, such as words in a sentence or the sentences themselves, into continuous vector representations. More specifically, embeddings are dense vector representations of words or tokens in a continuous vector space. A purpose of embeddings is to capture the semantic meaning and relationships between words. In an LLM, embeddings transform the discrete and sparse input text (typically represented as one-hot vectors) into continuous vectors that the model can process more effectively. Embeddings include dimensionality. For example, embeddings are typically lower-dimensional than the original one-hot encoded vectors, which reduces computational complexity and memory usage. Embeddings additionally include semantic relationships. For example, words with similar meanings or contexts have embeddings that are close to each other in the vector space, such as “account”, “teller”, and “bank”. This property allows the model to generalize and understand language better.

As mentioned earlier, the embeddings are trained via models, such as Word2Vec, GloVe, and FastText, to provide for style-based embeddings that incorporate certain styles and/or style attributes. For example, an embedding 408 is trained to represent one or more sentences using a certain a desired language complexity metric, a terminology metric, a tone metric, a format metric, and/or a level of detail metric. By training various embeddings 408, different styles and style attributes are then made available. Positional encodings are added to the input embeddings 408, 410 to provide information about the position of each word in the sequence. Unlike traditional recurrent neural networks (RNNs), transformers (the architecture used in many LLMs) process the entire sequence simultaneously without an inherent notion of word order. Positional encodings address this by introducing information about the position of each token. Positional encodings 408 are also trained for style so that certain words are positioned based on stylistic choices, e.g., via the aforementioned models used to train embeddings.

These embeddings and positional encodings are learned during the training process and capture semantic and syntactic properties of the tokens. This process allows the transformer model 400 to work with the input data in a more mathematical and computationally efficient manner. Also shown are audience and/or style-based embeddings 408. As mentioned earlier, in some examples, the techniques described herein use audience and/or style-based embeddings, such as the trained embeddings 408, to represent words and/or sentences used by various audiences and styles.

Since the transformer model 400 does not inherently understand the order of tokens in the sequence, positional encodings are added to the input embeddings to provide information about the position of each token in the sequence. This helps the transformer model 400 to maintain the sequence's order and understand the relative positions of tokens. The multi-head attention component 412 in the encoder of a transformer model is a mechanism designed to enable the model to focus on different parts of the input sequence simultaneously, capturing various aspects of the information contained within. This informs the understanding the complex relationships and dependencies in the data, such as the syntactic and semantic nuances in natural language processing tasks. Unlike recurrent neural networks, the attention mechanism can process all positions simultaneously via multiple “heads”, making it highly parallelizable and more efficient, especially for longer input sequences.

After obtaining the output from each head, a concatenation all the heads'outputs is then performed. An add & normalize block or layer 414 is then used for residual connection (add) and layer normalization (norm). Residual connections help to mitigate a vanishing gradient problem, which can be prevalent in deep networks. By adding the input directly to the output, the gradient has a shortcut path during backpropagation, making it easier to train very deep networks. Residual connections can be thought of as allowing the transformer model 400 to learn modifications to an identity function rather than learning the entire transformation. This can potentially make learning more efficient, as the model can focus on the changes or “residuals” needed. The layer normalization helps in stabilizing the learning process by ensuring that the outputs of the layers have a mean of 0 and a standard deviation of 1. This consistency can significantly improve the training speed and stability of deep neural networks.

The feed forward component or layer 416 consists of a position-wise fully connected feed-forward network that is applied to each position separately and identically. This means that the same feed-forward network is used for each position in the sequence, but it operates independently on each position. The purpose of the layer 416 is to introduce additional non-linearity into the model, allowing it to learn more complex patterns beyond what can be captured by the attention mechanism alone. A second add & normalize block or layer 418 is also shown, similar to the first add & normalize block or layer 414. The second add & normalize block or layer 418 also incorporates a residual connection. This time, the residual connection adds the output of the feed-forward network 414. This mechanism helps in preventing the vanishing gradient problem and allows for deeper models by facilitating the flow of gradients. Output of the add & normalize block or layer 418 is then sent to the decoder 406.

The decoder 406 processes the encoder output alongside its own input 420 (which, during training, is a target sequence shifted by one position to the right, indicating the next expected token). The decoder's architecture mirrors that of the encoder 402 but includes an additional attention mechanism to focus on appropriate parts of the encoder output. More specifically, the decoder 406 processes its input 420 by first converting it into embeddings and then adding positional encodings 422. This step ensures that the transformer model 400 maintains information about the order of tokens in the sequence 420.

The first block or layer is a masked multi-head attention block or layer 424. However, unlike in the encoder 402, this multi-head attention block or layer 424 is masked to prevent positions from attending to subsequent positions. This masking ensures that the predictions for position i can only depend on the known outputs at positions less than i, maintaining the autoregressive property of the decoder 406. An add & normalize block or layer 426 is then used, which as mentioned previously helps in stabilizing the training process and facilitates deeper models. A second, unmasked multi-head attention block or layer 428 is then used, in which the inputs (e.g., queries) come from the output of the add & normalize block or layer 424, and the keys and values come from the output of the encoder 402. This allows the decoder 406 to focus on different parts of the input sequence 404 as needed, based on the context provided by its own output 420 so far.

Another add & normalize block or layer 430 is then used, which aids in stabilizing training, as mentioned earlier, via residual connection and layer normalization. The add & normalize block or layer 430 provides its output to a feed forward block or layer 432. The feed forward block or layer 432 allows the transformer model 400 to learn more complex functions beyond what is captured by the attention layers 424, 428. While the attention layers 424, 428 help the transformer model 400 to focus on different parts of the input sequence and understand the relationships between them, the feed forward layer 432 provides the capacity to transform these relationships into a higher-level representation. Unlike the attention layers 424, 428 that operate on the entire sequence simultaneously to capture relationships between elements, the feed forward layer 432 processes each position independently. This design ensures that the transformer model 400 can apply the same transformation across different positions, allowing it to maintain a consistent approach to feature extraction and transformation across the sequence.

Output of the feed forward layer 432 is then provided to an add & normalize block or layer 434, which again aids in stabilizing training via residual connection and layer normalization. The add & normalize layer 434 then provides its output to a linear block or layer 436. The linear layer 436 transforms the high-dimensional representations output by the decoder's last layer into a vector of logits. Each logit corresponds to a score for each token in the model's vocabulary. The dimension of this output vector is equal to the size of the vocabulary. Being fully connected, the linear layer 436 connects each input feature to each output logit, ensuring that all aspects of the internal representation can contribute to the prediction of each token.

Following the linear transformation, a softmax block or layer 438 is applied to the logits to convert them into a probability distribution. Each element in this distribution represents the probability of a corresponding token being the next token in the sequence. The token with the highest probability can then be selected as an output 440 at each step in the sequence generation process. In sequence-to-sequence tasks, such as machine translation, text summarization, or even in generative tasks like text completion, the transformer model 400 iteratively generates the output sequence one token at a time, using the probabilities provided by the softmax layer 438 after the linear transformation at layer 436.

In some examples, the trained LLMs 134 and/or the styles 136 include the transformer model 400 and/or derivatives. Inputs 404, such as the requests to be processed by the audience-based generative AI system 102 are provided to the transformer model 400 via the UI system 116 and/or the API 130. The transformer model 400 then produces as output, for example, a base output, and/or adaptive audience output (when used to modify the base output). Likewise, the trained style-based embeddings and positional encodings 408 convert inputs into various styles (e.g., financial, legal, engineering styles) each style having substyles based on the various style attributes (e.g., language complexity, terminology, tone, format, and level of detail). By providing for a whole LLM and/or partial LLM (e.g., embedding and/or positional encoding) based approaches, the audience-based generative AI system 102 enhances user interaction and information delivery.

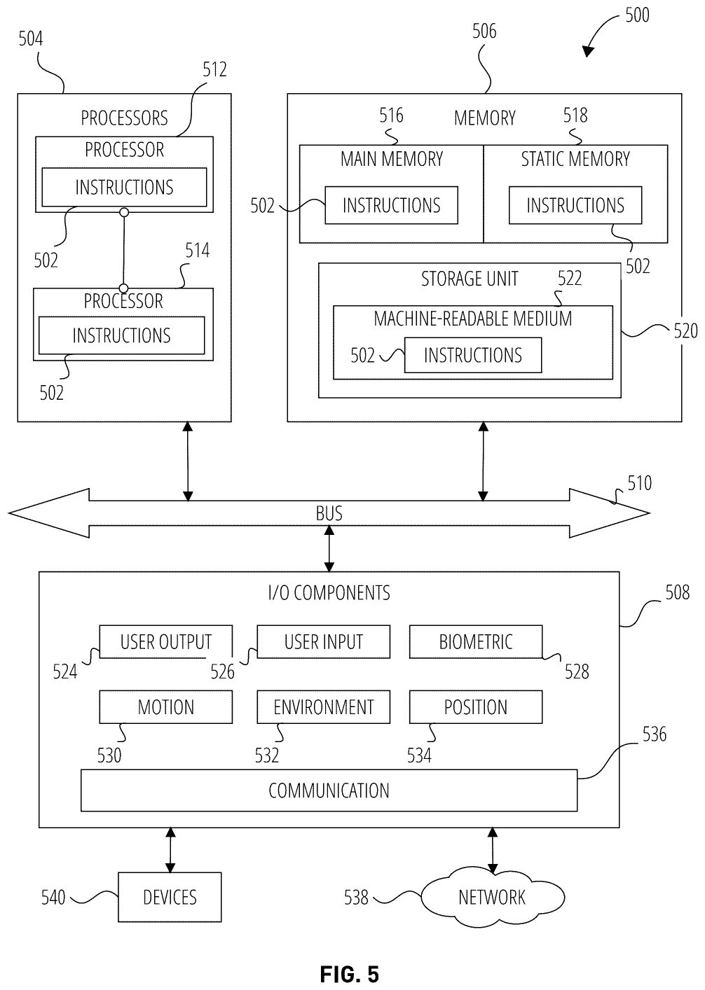

FIG. 5 is a diagrammatic representation of a machine 500 within which instructions 502 (e.g., software, a program, an application, an applet, an app, or other executable code) for causing the machine 500 to perform any one or more of the methodologies discussed herein may be executed. For example, the instructions 502 may cause the machine 500 to execute any one or more of the processes or methods described herein, such as the process 200. The instructions 502 transform the general, non-programmed machine 500 into a particular machine 500, e.g., the audience-based generative AI system 102, programmed to carry out the described and illustrated functions in the manner described. The machine 500 may operate as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 502, sequentially or otherwise, that specify actions to be taken by the machine 500. Further, while a single machine 500 is illustrated, the term “machine” shall also be taken to include a collection of machines that individually or jointly execute the instructions 502 to perform any one or more of the methodologies discussed herein. In some examples, the machine 500 may also comprise both client and server systems, with certain operations of a particular method or algorithm being performed on the server-side and with certain operations of the particular method or algorithm being performed on the client-side.

The machine 500 may include processors 504, memory 506, and input/output I/O components 508, which may be configured to communicate with each other via a bus 510. In an example, the processors 504 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), another processor, or any suitable combination thereof) may include, for example, a processor 512 and a processor 514 that execute the instructions 502. The term “processor” is intended to include multi-core processors that may comprise two or more independent processors (sometimes referred to as “cores”) that may execute instructions contemporaneously. Although FIG. 5 shows multiple processors 504, the machine 500 may include a single processor with a single-core, a single processor with multiple cores (e.g., a multi-core processor), multiple processors with a single core, multiple processors with multiples cores, or any combination thereof.

The memory 506 includes a main memory 516, a static memory 518, and a storage unit 520, both accessible to the processors 504 via the bus 510. The main memory 516, the static memory 518, and storage unit 520 store the instructions 502 embodying any one or more of the methodologies or functions described herein. The instructions 502 may also reside, completely or partially, within the main memory 516, within the static memory 518, within machine-readable medium 522 within the storage unit 520, within at least one of the processors 504 (e.g., within the processor's cache memory), or any suitable combination thereof, during execution thereof by the machine 500.

The I/O components 508 may include a wide variety of components to receive input, provide output, produce output, transmit information, exchange information, capture measurements, and so on. The specific I/O components 508 that are included in a particular machine will depend on the type of machine. For example, portable machines such as mobile phones may include a touch input device or other such input mechanisms, while a headless server machine will likely not include such a touch input device. It will be appreciated that the I/O components 508 may include many other components that are not shown in FIG. 5. In various examples, the I/O components 508 may include user output components 524 and user input components 526. The user output components 524 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 526 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 508 may include biometric components 528, motion components 530, environmental components 532, or position components 534, among a wide array of other components. For example, the biometric components 528 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 530 include acceleration sensor components (e.g., accelerometer), gravitation sensor components, rotation sensor components (e.g., gyroscope).

The environmental components 532 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 534 include location sensor components (e.g., a global positioning system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 508 further include communication components 536 operable to couple the machine 1200 to a network 538 or devices 540 via respective coupling or connections. For example, the communication components 536 may include a network interface component or another suitable device to interface with the network 538. In further examples, the communication components 536 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 540 may be another machine or any of a wide variety of peripheral devices (e.g., a peripheral device coupled via a universal serial bus (USB) port), internet-of-things (IoT) devices, and the like.

Moreover, the communication components 536 may detect identifiers or include components operable to detect identifiers. For example, the communication components 536 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 536, such as location via Internet Protocol (IP) geolocation, location via Wi-Fi® signal triangulation, location via detecting an NFC beacon signal that may indicate a particular location, and so forth.

The various memories (e.g., main memory 516, static memory 518, and memory of the processors 504) and storage unit 520 may store one or more sets of instructions and data structures (e.g., software) embodying or used by any one or more of the methodologies or functions described herein. These instructions (e.g., the instructions 502), when executed by processors 504, cause various operations to implement the disclosed examples.

The instructions 502 may be transmitted or received over the network 538, using a transmission medium, via a network interface device (e.g., a network interface component included in the communication components 536) and using any one of several well-known transfer protocols (e.g., hypertext transfer protocol (HTTP)). Similarly, the instructions 502 may be transmitted or received using a transmission medium via a coupling (e.g., a peer-to-peer coupling) to the devices 540.

What is claimed is:

1. A method, comprising:
receiving a request from a requestor for an artificial intelligence (AI)-generated output;
determining an intended audience for the AI-generated output based on the request;
creating an audience-based response to the request by using a trained large language model (LLM) or a combination of the trained LLM and an LLM style-based embedding, wherein using the trained LLM comprises:
generating a base response to the request using the trained LLM, and
applying one or more audience-specific transformation systems to the base response to create the audience-based response, wherein the one or more audience-specific transformation systems are configured to modify the base response for the intended audience, and
wherein using the LLM style-based embedding comprises:
creating, based on the LLM style-based embedding, a word representation of at least a portion of the request, and
generating an audience-based response by using the trained LLM to output the audience-based response based in part on the word representation; and
providing the audience-based response as the AI-generated output to the requestor.

2. The method of claim 1, wherein at least one of the one or more audience-specific transformation systems comprises a second trained LLM that is trained on a styles dataset, and wherein applying the one or more audience-specific transformation systems further comprises providing the second LLM with the base response as input and using an output of the second trained LLM as the audience-based response.

3. The method of claim 2, wherein the styles dataset comprises data and labels, the labels identifying a language complexity, a terminology, a tone, a format, a level of detail metric, or a combination thereof, of the data.

4. The method of claim 2, further comprising training the second trained LLM on the styles dataset by using supervised learning of the styles dataset, unsupervised learning of the styles dataset, or a combination thereof.

5. The method of claim 2, further comprising selecting, based on the intended audience, the second trained LLM from a plurality of trained LLMs for modification of the base response.

6. The method of claim 1, wherein the word representation comprises a dense vector representation of one or more words or tokens in a continuous vector space.

7. The method of claim 6, wherein the word representation comprises a positional encoding of the one or more words or tokens based on one or more style attributes of the LLM style-based embedding.

8. The method of claim 7, wherein the one or more style attributes comprise a language complexity, a terminology, a tone, a format, a level of detail, or a combination thereof.

9. The method of claim 1, further comprising creating the LLM style-based embedding by concatenating a selected embedding that is selected based on the intended audience to a base representation embedding.

10. The method of claim 1, wherein determining the intended audience for the AI-generated output further comprises authenticating the request via a login, and determining the intended audience using the login.

11. The method of claim 10, wherein determining the intended audience using the login comprises retrieving a role based on the login, and determining the intended audience using the role.

12. The method of claim 1, wherein determining the intended audience for the AI-generated output based on the request comprises evaluating a language style of the request to determine if the language style is associated with at least one audience of a set of audiences.

13. The method of claim 1, wherein the intended audience is determined to be a financial expert audience, a legal expert audience, an information technology expert audience, an engineering expert audience, a manufacturing expert audience, a customer of an organization audience, or a layperson audience.

14. A system comprising:
one or more hardware processors; and
at least one memory storing instructions that cause the one or more hardware processors to perform operations comprising:
receiving a request from a requestor for an artificial intelligence (AI)-generated output;
determining an intended audience for the AI-generated output based on the request;
creating an audience-based response to the request by using a trained large language model (LLM) or a combination of the trained LLM and an LLM style-based embedding, wherein using the trained LLM comprises:
generating a base response to the request using the trained LLM, and
applying one or more audience-specific transformation systems to the base response to create the audience-based response, wherein the one or more audience-specific transformation systems are configured to modify the base response for the intended audience, and
wherein using the LLM style-based embedding comprises:
creating, based on the LLM style-based embedding, a word representation of at least a portion of the request, and
generating an audience-based response by using the trained LLM to output the audience-based response based in part on the word representation; and
providing the audience-based response as the AI-generated output to the requestor.

15. The system of claim 14, wherein at least one of the one or more audience-specific transformation systems comprises a second trained LLM that is trained on a styles dataset, and wherein the instructions for applying the one or more audience-specific transformation systems further comprise instructions for providing the second LLM with the base response as input and using an output of the second trained LLM as the audience-based response.

16. The system of claim 15, wherein the styles dataset comprises data and labels, the labels identifying a language complexity, a terminology, a tone, a format, a level of detail metric, or a combination thereof, of the data.

17. The system of claim 15, further comprising instructions for creating the LLM style-based embedding by concatenating a selected embedding that is selected based on the intended audience to a base representation embedding.

18. A machine-readable medium storing instructions that, when executed by a computer system, cause the computer system to perform operations comprising:
receiving a request from a requestor for an artificial intelligence (AI)-generated output;
determining an intended audience for the AI-generated output based on the request;
creating an audience-based response to the request by using a trained large language model (LLM) or a combination of the trained LLM and an LLM style-based embedding, wherein using the trained LLM comprises:
generating a base response to the request using the trained LLM, and
applying one or more audience-specific transformation systems to the base response to create the audience-based response, wherein the one or more audience-specific transformation systems are configured to modify the base response for the intended audience, and
wherein using the LLM style-based embedding comprises:
creating, based on the LLM style-based embedding, a word representation of at least a portion of the request, and
generating an audience-based response by using the trained LLM to output the audience-based response based in part on the word representation; and
providing the audience-based response as the AI-generated output to the requestor.

19. The machine-readable medium storing instructions of claim 18, wherein at least one of the one or more audience-specific transformation systems comprises a second trained LLM that is trained on a styles dataset, and wherein the instructions for applying the one or more audience-specific transformation systems further comprise instructions for providing the second LLM with the base response as input and using an output of the second trained LLM as the audience-based response.

20. The machine-readable medium storing instructions of claim 19, wherein creating the audience-based response further comprises instructions for creating the LLM style-based embedding by concatenating a selected embedding that is selected based on the intended audience to a base representation embedding.
